(19) United States
(12) Patent Application Publication
(10) Pub. No.: US 2018/0124378 A1
(43) Pub. Date: May 3, 2018

(54) ENHANCED DEPTH MAP IMAGES FOR MOBILE DEVICES

(71) Applicant: QUALCOMM Incorporated, San Diego, CA (US)

(72) Inventors: Bijan Forutanpour, San Diego, CA (US); Stephen Michael Verrall, Carlsbad, CA (US); Kalin Mitkov Atanassov, San Diego, CA (US); Albrecht Johannes Lindner, La Jolla, CA (US)

(21) Appl. No.: 15/342,912

(22) Filed: Nov. 3, 2016

(51) Int. Cl. H04N 13/02

(52) U.S. Cl. CPC H04N 13/0225; H04N 2013/0081

(57) ABSTRACT

In general, techniques are described that facilitate processing of a depth map image in mobile devices. A mobile device comprising a depth camera, a camera and a processor may be configured to perform various aspects of the techniques. The depth camera may be configured to capture a depth map image of a scene. The camera may include a linear polarization unit configured to linearly polarize light entering into the camera. The camera may be configured to rotate the linearly polarization unit during capture of the scene to generate a sequence of linearly polarized images of the scene having different polarization orientations. The processor may be configured to perform image registration with respect to the sequence of linearly polarized images to generate a sequence of aligned linearly polarized images, and generate an enhanced depth map image based on the depth map image and the sequence of aligned linearly polarized images.

### TECHNICAL FIELD

This disclosure relates to image generation, and more particularly to depth map image generation.

### BACKGROUND

Mobile communication devices, such as smart phones or camera phones, are increasingly becoming the camera of choice for consumers. As the optics of the cameras included in such mobile communication devices continue to improve to allow for better photo and video capture, the consumer may move away from using more traditional cameras, such as digital single-lens reflex (DSLR) cameras. To continue to promote adoption of smart phones as the camera of choice for consumers, new applications are being developed in which cameras are used to create three-dimensional models of objects for various purposes, such as three-dimensional printing, rendering of objects for virtual reality, computer vision, and the like.

### SUMMARY

The techniques described in this description may provide for enhanced depth maps having sub-millimeter accuracy using cameras of mobile computing devices, rather than accuracy in the millimeter range for current cameras of mobile computing devices. By enabling sub-millimeter accuracy, the techniques may allow for capture of finer model geometry, such as sharp corners, flat surfaces, narrow objects, ridges, grooves, etc. The higher resolution may allow for results that promote adoption of cameras in mobile computing devices for applications such as virtual reality (VR), augmented reality (AR), three-dimensional (3D) modeling, enhanced three-dimensional (3D) image capture, etc.

In one example, various aspects of the techniques are directed to a mobile device configured to process a depth map image, the mobile device comprising a depth camera configured to capture a depth map image of a scene, a camera including a linear polarization unit configured to linearly polarize light entering into the camera, the camera configured to rotate the linear polarization unit during capture of the scene to generate a sequence of linearly polarized images of the scene having different polarization orientations, and a processor. The processor may be configured to perform image registration with respect to the sequence of linearly polarized images to generate a sequence of aligned linearly polarized images, and generate an enhanced depth map image based on the depth map image and the sequence of aligned linearly polarized images.

In another example, various aspects of the techniques are directed to a method of processing a depth map image, the method comprising capturing, by a depth camera, a depth map image of a scene, and rotating a linear polarization unit during capture of the scene by a color camera to generate a sequence of linearly polarized images of the scene having different polarization orientations. The method also comprises performing image registration with respect to the sequence of linearly polarized images to generate a sequence of aligned linearly polarized images, and generating an enhanced depth map image based on the depth map image and the sequence of aligned linearly polarized images.

In another example, various aspects of the techniques are directed to a device configured to process a depth map image, the device comprising means for capturing a depth map image of a scene, means for capturing a sequence of linearly polarized images of the scene having different polarization orientations, means for performing image registration with respect to the sequence of linearly polarized images to generate a sequence of aligned linearly polarized images; and means for generating an enhanced depth map image based on the depth map image and the sequence of aligned linearly polarized images.

In another example, various aspects of the techniques are directed to A non-transitory computer-readable storage medium having stored thereon instructions that, when executed, cause one or more processors of a mobile device to interface with a depth camera to capture of a depth map image of a scene, interface with a color camera to capture a sequence of linearly polarized images of the scene having different polarization orientations, perform image registration with respect to the sequence of linearly polarized images to generate a sequence of aligned linearly polarized images, and generate an enhanced depth map image based on the depth map image and the sequence of aligned linearly polarized images.

The details of one or more examples of the techniques are set forth in the accompanying drawings and the description below. Other features, objects, and advantages of the techniques will be apparent from the description, drawings, and claims.

### BRIEF DESCRIPTION OF THE DRAWINGS

FIG. 1 is a block diagram of a device for image processing configured to perform one or more example techniques described in this disclosure.

FIG. 2 is a block diagram illustrating an example of the color camera of the mobile computing device of FIG. 1 in more detail.

FIGS. 3A-3D are diagrams illustrating example rotation of linear polarization unit shown in FIG. 1 so as to capture a sequence of linearly polarized images having different polarization orientations in accordance with various aspects of the techniques described in this disclosure.

FIG. 4 is a diagram illustrating a composite of a sequence of two linearly polarized images of color image data overlaid upon one another to demonstrate various offsets that occur when employing the color camera of the mobile computing device shown in FIG. 1 to capture images.

FIG. 5 is a diagram illustrating an example algorithm that, when executed, causes the mobile computing device of FIG. 1 to be configured to perform various aspects of the techniques described in this disclosure.

FIG. 6 is flowchart illustrating example operation of the mobile computing device of FIG. 1 in performing various aspects of the techniques described in this disclosure.

### DETAILED DESCRIPTION

The techniques described in this description may provide for enhanced depth maps having sub-millimeter accuracy using cameras of mobile computing devices, rather than accuracy in the millimeter range for current cameras of mobile computing devices. By enabling sub-millimeter accuracy, the techniques may allow for capture of finer model geometry, such as sharp corners, flat surfaces, narrow objects, ridges, grooves, etc. The higher resolution may allow for results that promote adoption of cameras in mobile computing devices for applications, such as virtual reality, augmented reality, three-dimensional modeling, enhanced three-dimensional (3D) image capture, etc.

In operation, the mobile communication device may comprise a camera including a rotatable linear polarizing filter or rotatable linearly polarized lens. A linear polarizing filter may refer to a filter that removes, or in other words, blocks light waves having polarization that does not align with the polarization of the filter. That is, a linear polarizing filter may convert a beam of light of undefined or mixed polarization into a beam of well-defined polarization, which in the case of a linear polarizing filter having a polarization oriented along some line. The mobile communication device may also include a rotating motor to rotate the rotatable linear polarizing filter or lens. The mobile communication device may operate the rotation motor such that rotation of the rotatable linear polarizing filter or the rotatable linear polarizing lens is synchronized with the frame capture rate of the camera. In some instances, rather than synchronize rotation of the rotatable linear polarizing filter or lens to the frame capture rate, the mobile communication device may determine the rotation angle at the time of frame capture.

After capturing the sequence of linear polarized images (each being captured with the linear polarizing filter or lens positioned at a different rotation angle), the mobile communication device may perform image alignment to compensate for slight movements of the mobile communication device or camera when capturing the sequence of images. In some examples, the mobile communication device may include one or more motion sensors, such as a gyroscope and/or accelerometer, that outputs motion information. The mobile communication device may perform image alignment based on the motion information generated by the motion sensors.

The mobile communication device may also include a depth camera that, concurrently with the capture of the set of linear polarized images, captures one or more images to generate a coarse depth image. The mobile communication device may also perform image alignment between the sequence of linear polarized images and the coarse depth image, which may in some examples also be based on the motion information. The image alignment may also be referred to as “registration” or “image registration.”

After performing the image alignment, the mobile communication device may perform shape-from-polarization depth map augmentation processes, e.g., as described in a research paper by Kadambi, et al., entitled “Polarized 3D: High-Quality Depth Sensing with Polarization Cues,” and presented during the International Conference on Computer Vision (ICCV) in Santiago, Chile from Dec. 13-16, 2015, to generate an enhanced depth map image.

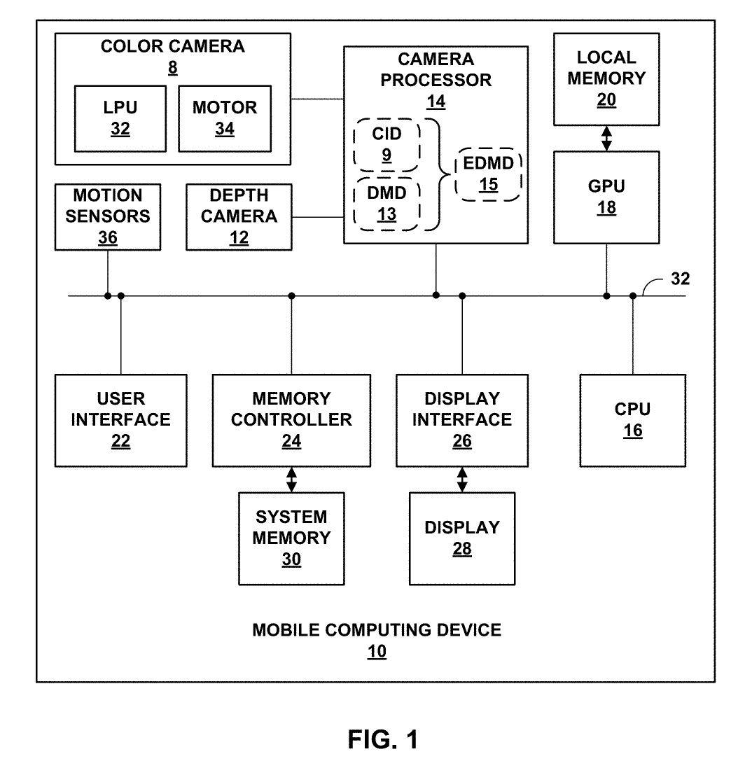

FIG. 1 is a block diagram of a mobile computing device for image processing configured to perform one or more example techniques described in this disclosure. Examples of mobile computing device 10 include a laptop computer, a wireless communication device or handset (such as, e.g., a mobile telephone, a cellular telephone, a so-called “smart phone,” a satellite telephone, and/or a mobile telephone handset), a handheld device—such as a portable video game device or a personal digital assistant (PDA), a personal music player, a tablet computer, a portable video player, a portable display device, a standalone camera, or any other type of mobile device that includes a camera to capture photos or other types of image data. While described with respect to mobile computing device 10, the techniques may be implemented by any type of device, whether considered mobile or not, such as by a desktop computer, a workstation, a set-top box, or a television to provide a few examples.

As illustrated in the example of FIG. 1, device 10 includes a color camera 8, a depth camera 12, a camera processor 14, a central processing unit (CPU) 16, a graphical processing unit (GPU) 18 and local memory 20 of GPU 18, user interface 22, memory controller 24 that provides access to system memory 30, and display interface 26 that outputs signals that cause graphical data to be displayed on display 28.

Also, although the various components are illustrated as separate components, in some examples the components may be combined to form a system on chip (SoC). As an example, camera processor 14, CPU 16, GPU 18, and display interface 26 may be formed on a common chip. In some examples, one or more of camera processor 14, CPU 16, GPU 18, and display interface 26 may be in separate chips.

The various components illustrated in FIG. 1 may be formed in one or more microprocessors, application specific integrated circuits (ASICs), field programmable gate arrays (FPGAs), digital signal processors (DSPs), or other equivalent integrated or discrete logic circuitry. The various components may be any combination of the foregoing as well, including functional logic, programmable logic or combinations thereof. Examples of local memory 20 include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 22. Bus 22 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different units shown in FIG. 1 is merely exemplary, and other configurations of computing devices and/or other image processing systems with the same or different components may be used to implement the techniques of this disclosure.

As illustrated, device 10 includes color camera 8 and depth camera 12. Cameras 8 and 12 need not necessarily be part of device 10 and may be external to device 10. In such examples, camera processor 14 may similarly be external to device 10; however, it may be possible for camera processor 14 to be internal to device 10 in some examples. For ease of description, the examples are described with respect to cameras 8 and 12 and camera processor 14 being part of device 10 (e.g., such as in examples where device 10 is a mobile communication device such as a smartphone, tablet computer, handset, mobile communication handset, or the like).

Color camera 8 as used in this disclosure refer to a sets of pixels. In some examples, color camera 8 may be considered as including a plurality of sensors, and each sensor includes a plurality of pixels. For example, each sensor includes three pixels (e.g., a pixel for red, a pixel for green, and a pixel for blue). As another example, each sensor includes four pixels (e.g., a pixel for red, two pixels for green used to determine the green intensity and overall luminance, a pixel for blue as arranged with a Bayer filter). Color camera 8 may capture image content to generate one image.

Although described with respect to a single color camera 8, the techniques may be performed by devices having multiple color cameras, a device having a single color camera with multiple different sensors, or a device having a color camera and a monochrome camera. In instances where the device configured to perform the techniques of this disclosure includes multiple color and/or monochrome cameras, each camera may capture an image to which camera processor 14 may perform image registration to generate a single image of the scene, with potentially a higher resolution. Furthermore, while described with respect to color camera 8, the techniques may also be performed by a device having one or more monochrome cameras instead of color camera 8.

The pixels of color camera 8 should not be confused with image pixels. Image pixel is the term used to define a single “dot” on the generated image from the content captured by color camera 8. For example, the image generated based on the content captured by any color camera 8 includes a determined number of pixels (e.g., megapixels). However, the pixels of color camera 8 are the actual photosensor elements having photoconductivity (e.g., the elements that capture light particles in the viewing spectrum or outside the viewing spectrum). The pixels of color camera 8 conduct electricity based on intensity of the light energy (e.g., infrared or visible light) striking the surface of the pixels. The pixels may be formed with germanium, gallium, selenium, silicon with dopants, or certain metal oxides and sulfides, as a few non-limiting examples.

In some examples, the pixels of color camera 8 may be covered with red-green-blue (RGB) color filters in accordance with a Bayer filter. With Bayer filtering, each of the pixels may receive light energy for a particular color component (e.g., red, green, or blue). Accordingly, the current generated by each pixel is indicative of the intensity of red, green, or blue color components in the captured light.

Depth camera 12 represents a camera configured to generate a depth map. Depth camera 12 may include an infrared laser projector and a monochrome sensor. The infrared laser projector may project a grid of infrared light points onto the scene. The monochrome sensor (or, alternatively, color sensor) may detect reflections from projecting the infrared light points onto the scene. The monochrome sensor may generate an electrical signal for each pixel of the sensor indicating when the infrared light point reflection is detected.

Camera processor 14 may determine a depth at each corresponding one of the infrared light points projected onto the scene based on the speed of light, a time at which each infrared light point was projected and a time at which each infrared light point reflection was detected. Camera processor 14 then formulates the depth map based on the determined depth at each infrared light point in the grid. Although described with respect to an infrared projection of light points, depth camera 12 may represent any type of camera capable of generating a depth map and should not be limited strictly to those cameras employing infrared light.

Camera processor 14 is configured to receive the electrical currents from respective pixels of color camera 8 and depth camera 12 and process the electrical currents to generate color image data 9 (CID) and depth map data (DMD) 13. Although one camera processor 14 is illustrated, in some examples, there may be a plurality of camera processors (e.g., one per color camera 8 and depth camera 12). Accordingly, in some examples, there may be one or more camera processors like camera processor 14 in device 10.

In some examples, camera processor 14 may be configured as a single-input-multiple-data (SIMD) architecture. Camera processor 14 may perform the same operations on current received from each of the pixels on each of cameras 8 and 12. Each lane of the SIMD architecture includes an image pipeline. The image pipeline includes fixed function circuitry and/or programmable circuitry to process the output of the pixels.

For example, each image pipeline of camera processor 14 may include respective trans-impedance amplifiers (TIAs) to convert the current to a voltage and respective analog-to-digital converters (ADCs) that convert the analog voltage output into a digital value. In the example of the visible spectrum, because the current outputted by each pixel indicates the intensity of a red, green, or blue component, the digital values from three pixels of camera 8 (e.g., digital values from one sensor that includes three or four pixels) can be used to generate one image pixel.

In addition to converting analog current outputs to digital values, camera processor 14 may perform some additional post-processing to increase the quality of the final image. For example, camera processor 14 may evaluate the color and brightness data of neighboring image pixels and perform demosaicing to update the color and brightness of the image pixel. Camera processor 14 may also perform noise reduction and image sharpening, as additional examples. Camera processor 14 outputs the resulting images (e.g., pixel values for each of the image pixels) to system memory 30 via memory controller 24.

CPU 16 may comprise a general-purpose or a special-purpose processor that controls operation of device 10. A user may provide input to computing device 10 to cause CPU 16 to execute one or more software applications. The software applications executing within the execution environment provided by CPU 16 may include, for example, an operating system, a word processor application, an email application, a spread sheet application, a media player application, a video game application, a graphical user interface application or another program. The user may provide input to computing device 10 via one or more input devices (not shown) such as a keyboard, a mouse, a microphone, a touch pad, a touch-sensitive screen, physical input buttons, or another input device that is coupled to mobile computing device 10 via user interface 22.

As one example, the user may execute an application to capture an image. The application may present real-time image content on display 28 for the user to view prior to taking an image. In some examples, the real-time image content displayed on display 28 may be the content from color camera 8, depth camera 12 or a fusion of content from color camera 8 and depth camera 12. The software code for the application used to capture image may be stored on system memory 30 and CPU 16 may retrieve and execute the object code for the application or retrieve and compile source code to obtain object code, which CPU 16 may execute to present the application.

When the user is satisfied with the real-time image content, the user may interact with user interface 22 (which may be a graphical button displayed on display 28) to capture the image content. In response, one or more cameras 8 and 12 may capture image content and camera processor 14 may process the received image content to generate one or more images.

Memory controller 24 facilitates the transfer of data going into and out of system memory 30. For example, memory controller 24 may receive memory read and write commands, and service such commands with respect to memory 30 in order to provide memory services for the components in mobile computing device 10. Memory controller 24 is communicatively coupled to system memory 30. Although memory controller 34 is illustrated in the example computing device 10 of FIG. 1 as being a processing module that is separate from both CPU 16 and system memory 30, in other examples, some or all of the functionality of memory controller 24 may be implemented on one or both of CPU 46 and system memory 30.

System memory 30 may store program modules and/or instructions and/or data that are accessible by camera processor 14, CPU 16, and GPU 18. For example, system memory 30 may store user applications, resulting images from camera processor 14, intermediate data, and the like. System memory 30 may additionally store information for use by and/or generated by other components of mobile computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 30 may include instructions that cause camera processor 14, CPU 16, GPU 18, and display interface 26 to perform the functions ascribed to these components in this disclosure. Accordingly, system memory 30 may represent a computer-readable storage medium having instructions stored thereon that, when executed, cause one or more processors (e.g., camera processor 14, CPU 16, GPU 18, and display interface 26) to perform various aspects of the techniques described in this disclosure.

In some examples, system memory 30 may represent a non-transitory computer-readable storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from device 10, and moved to another device. As another example, memory, substantially similar to system memory 30, may be inserted into device 10. In certain examples, a non-transitory storage medium may store data that can, over time, change (e.g., in RAM).

Camera processor 14, CPU 16, and GPU 18 may store image data, and the like in respective buffers that are allocated within system memory 30. Display interface 26 may retrieve the data from system memory 30 and configure display 28 to display the image represented by the rendered image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 28 may be integrated within mobile computing device 10. For instance, display 28 may be a screen of a mobile telephone handset or a tablet computer. Alternatively, display 28 may be a stand-alone device coupled to mobile computing device 10 via a wired or wireless communications link. For instance, display 28 may be a computer monitor or flat panel display connected to a personal computer via a cable or wireless link.

In accordance with the techniques described in this disclosure, mobile computing device 10 may provide for enhanced depth maps having sub-millimeter accuracy using cameras 8 and 12. As shown in FIG. 1, color camera 8 may include a rotatable linear polarizing unit 32 (“LPU 32”), which may represent a linearly polarized filter and/or linearly polarized lens. Color camera 8 may also include a motor 34 configured to rotate LPU 32. Color camera 8 may operate motor 34 such that rotation of LPU 32 is synchronized with the frame capture rate of the camera. In some instances, rather than synchronize rotation of LPU 32 to the frame capture rate, camera processor 14 may determine the rotation angle at the time of frame capture.

After capturing the sequence of linear polarized images (each being captured with the linear polarizing filter or lens positioned at a different rotation angle) as CID 9, the camera processor 14 may perform image alignment to compensate for slight movements of mobile communication device 10 or camera 8 when capturing CID 9. In some examples, mobile communication device 10 may include one or more motion sensors 36, such as a gyroscope and/or accelerometer, that outputs motion information. Camera processor 14 may perform image alignment based on the motion information generated by motion sensors 36 coincident with capture of the frames.

Concurrent to the capture of CID 9 (which may refer to the set of linear polarized images), camera processor 14 may interface with depth camera 12 to capture one or more images to generate a coarse depth image, which is shown in FIG. 1 as depth map data 13 (“DMD 13”). Camera processor 14 may also perform image alignment between CID 9 and DPD 13, which may in some examples also be based on the motion information from motion sensor 36. Image alignment may also be referred to in this disclosure as “registration” or “image registration.”

Image alignment (or, image registration) may refer to a process of transforming different sets of image data (e.g., CID 9 and/or DMD 13) into one coordinate system. Camera processor 14 may perform different variations of image alignment, such as intensity-based image alignment or feature-based image alignment. Intensity-based image alignment may include a comparison of intensity patterns between CID 9 and/or DMD 13 using correlation metrics. Feature-based image alignment may include a determination of correspondence between image features extracted from CID 9 and/or DMD 13, where such features may include points, lines, and contours. Based on the intensity pattern comparison or feature correspondence, camera processor 14 may determine a geometrical transform to map CID 9 and/or DMD 13 to one of CID 9 and/or DMD 13 selected as the reference image. Camera processor 14 may apply the geometrical transform to each of the non-reference CID 9 and/or DMD 13 to shift or otherwise align pixels of the non-reference CID 9 and/or DMD 13 to the reference CID 9 and/or DMD 13.

After performing the image alignment, camera processor 14 may perform shape-from-polarization depth map augmentation processes described in the above-referenced Kadambi research paper to generate enhanced depth map data 15 (“EDMD 15”). Generally, the Kadambi research paper describes a process by which DMD 13 can be enhanced using the shape information from polarization cues. The framework set forth by the Kadambi research paper combines surface normal form polarization (such as after-polarization normal) with an aligned depth map. The Kadambi research paper recognizes that polarization normals may suffer from physics-based artifacts, such as azimuthal ambiguity, refractive distortion and fronto-parallel signal degredation, and potentially overcomes these physics-based artifacts to permit generation of EDMD 15.

Based on EDMD 15, one or more of camera processor 14, CPU 16 and GPU 18 may construct a three-dimensional model of at least one aspect of the scene. For example, the scene may comprise an item that an operator of mobile computing device 10 is interested in modeling (e.g., for purposes of presenting the model via a display on a retail website, placing in a graphically generated virtual reality scene, etc.). Mobile computing device 10 may interface with or otherwise incorporate a display (e.g., user interface 22 or display interface 26) for presenting the three-dimensional model.

In this respect, mobile computing device 10 may represent one example of a mobile device configured to process a course depth map image (e.g., DMD 13) to generate an enhanced depth map image (e.g., EDMD 15). Color camera 8, to facilitate generation of EDMD 15, includes LPU 32 configured to linearly polarize light entering into the camera. Color camera 8 further includes motor 34, which is configured to rotate the LPU 32 during capture of the scene to generate a sequence of linearly polarized images of the scene having different polarization orientations. CID 9 may represent the sequence of linearly polarized images of the scene having different polarization orientations.

Camera processor 14 may represent one example of a processor configured to perform the above noted image registration with respect to CID 9. After image registration, CID 9 may also represent a sequence of aligned linearly polarized images. As such, camera processor 14 may perform registration to generate CID 9. Camera processor 14 may next perform the Kadambi shape-from-polarization depth map augmentation processes to generate EDMD 15 based on DMD 13 and aligned CID 9.

In this way, the techniques described in this description may provide for enhanced depth maps having sub-millimeter accuracy using cameras of mobile computing devices, rather than accuracy in the millimeter range for current cameras of mobile computing devices. By enabling sub-millimeter accuracy, the techniques may allow for capture of finer model geometry, such as sharp corners, flat surfaces, narrow objects, ridges, grooves, etc. The higher resolution may allow for results that promote adoption of cameras in mobile computing devices for applications, such as virtual reality, augmented reality, three-dimensional modeling, enhanced three-dimensional (3D) image capture, etc.

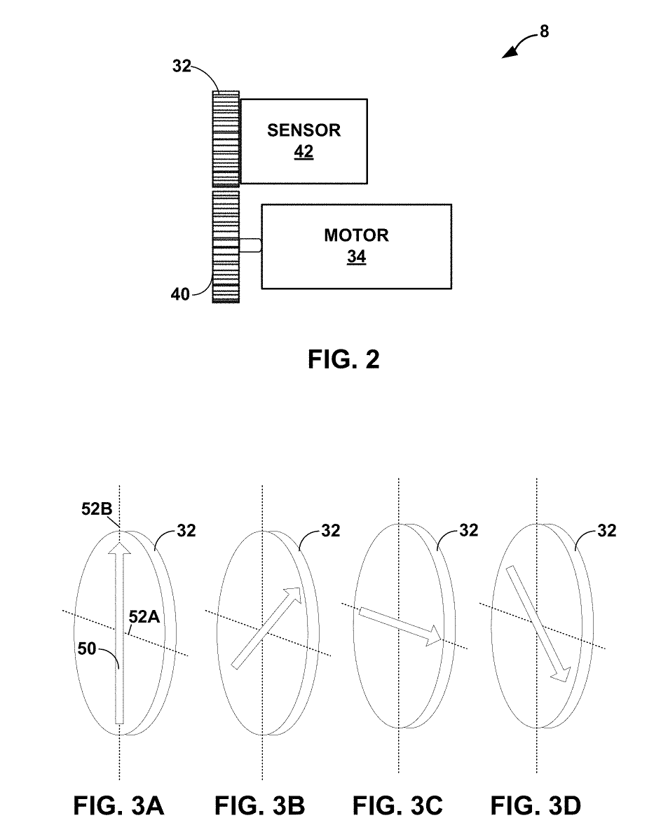

FIG. 2 is a block diagram illustrating an example of color camera 8 of FIG. 1 in more detail. Color camera 8 includes LPU 32 and motor 34 as previously described. Motor 34 is coupled to a gear 40, which matches gearing of LPU 32. Motor 34 may drive gear 40 to rotate LPU 32. Motor 34 may driver gear 40 in predetermined, set increments and with sufficient speed to synchronize with capture of images by a sensor 42 of color camera 8, such that CID 9 may include a sequence of linearly polarized images having different, known polarization orientations. Alternatively, camera processor 14 may derive the polarization orientation as a function, at least in part, of a speed with which motor 34 may rotate LPU 32 and a time between capture of each successive image in the sequence of linearly polarized images of CID 9.

FIGS. 3A-3D are diagrams illustrating example rotation of LPU 32 by motor 34 so as to capture a sequence of linearly polarized images having different polarization orientations in accordance with various aspects of the techniques described in this disclosure. In the example of FIG. 3A, arrow 50 represents a linear polarization orientation, while dashed arrows 52A and 52B represent the x- and y-axis, respectively. Color camera 8 may capture, as shown in the example of FIG. 3A, a first linearly polarized image in the sequence of linearly polarized images having a polarization orientation of zero degrees (0°).

Referring to the example of FIG. 3B, color camera 8 may capture a second linearly polarized image in the sequence of linearly polarized images having a polarization orientation of 45 degrees (45°) relative to the first linearly polarized image. Because linear polarization is non-directional, a polarization orientation of 45 degrees may be considered the same as a polarization orientation of 225 degrees.

In the example of FIG. 3C, color camera 8 may capture a third linearly polarized image in the sequence of linearly polarized images having a polarization orientation of 90 degrees (90°) relative to the first linearly polarized image. Because linear polarization is non-directional, a polarization orientation of 90 degrees may be considered the same as a polarization orientation of 270 degrees.

Referring to the example of FIG. 3D, color camera 8 may capture a fourth linearly polarized image in the sequence of linearly polarized images having a polarization orientation of 135 degrees (135°) relative to the first linearly polarized image. Because linear polarization is non-directional, a polarization orientation of 135 degrees may be considered the same as a polarization orientation of 315 degrees.

In this respect, camera processor 8 may interface with camera 8 to synchronize rotation of the linear polarization unit and the capture of the sequence of linearly polarized images defined by CID 9 such that the difference in polarization orientations between successive linearly polarized images is fixed (e.g., to 45 degree increments). Camera processor 8 may then determine the polarization orientations as a function of, in this example, 45 degree increments.

Although described with respect to 45 degree increments of polarization orientation, color camera 8 may capture sequences of linearly polarized images having different polarization orientation increments or, as noted above, variable polarization orientations that are not a function of set degree increments. In this respect, camera processor 14 may be configured to determine the polarization orientation of each of the sequence of linearly polarized images defined by CID 9, e.g., as a function of a speed with which motor 34 may rotate LPU 32 and a time between capture of each successive image in the sequence of linearly polarized images of CID 9. Whether employing fixed polarization orientations or variable polarization orientations, camera processor 14 may then determine EDMD 15 based on DMD 13, CID 9, and the determined polarization orientations.

Moreover, polarization orientation may refer to an orientation of polarization in a two-dimensional plane (e.g., the X-Y plane defined by x- and y-axis 52A and 52B) parallel to a lens of color camera 8, and not a three-dimensional orientation of LPU 32. As such, the polarization orientation refers to a degree of rotation of LPU 32 defined in a two-dimensional coordinate system fixed in space at LPU 32 (meaning that the two-dimensional coordinate system moves with LPU 32 and has a center at the center of LPU 32—or some other location of LPU 32). The polarization orientation may not change despite movement of LPU 32 considering that the coordinate system is relative to the location of LPU 32 and not an absolute location in space.

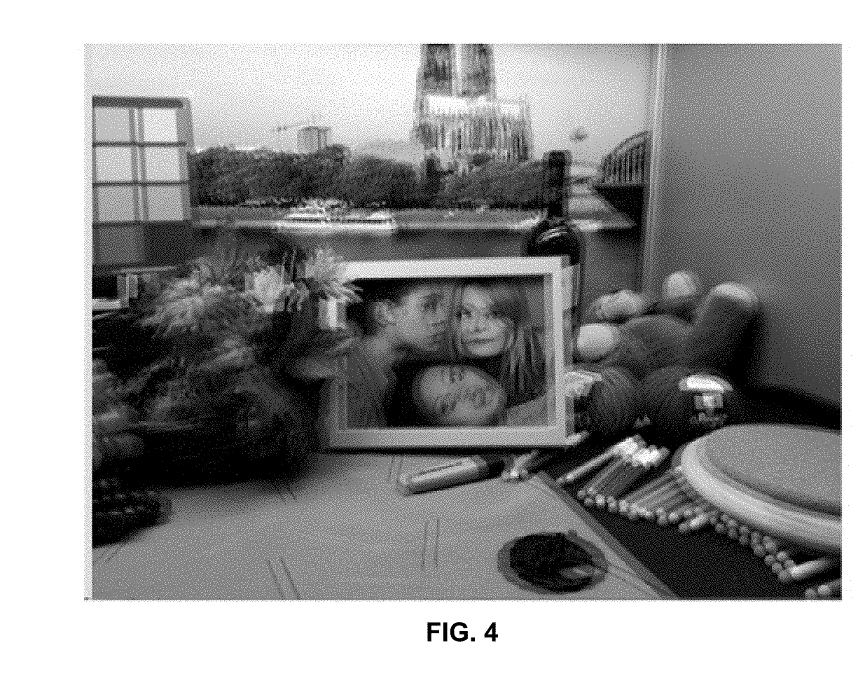

FIG. 4 is a diagram illustrating a composite of a sequence of two linearly polarized images of CID 9 overlaid upon one another to demonstrate various offsets that occur when employing color camera 8 of mobile computing device 10 to capture images. As shown in the example of FIG. 4, there is an offset between the two overlaid images that results in blurred edges and other visual artifacts. Camera processor 14 may perform image registration with respect to the two linearly polarized images of CID 9 to reduce if not eliminate the blurred edges and other visual artifacts. More information regarding image registration can be found in slides presented by Professor Kheng, entitled “Image Registration,” in the Computer Vision and Pattern Recognition class of the Department of Computer Science at the National University of Singapore, and in the article by George Wolberg, et al., entitled “Robust Image Registration Using Log-Polar Transform,” published September, 2000.

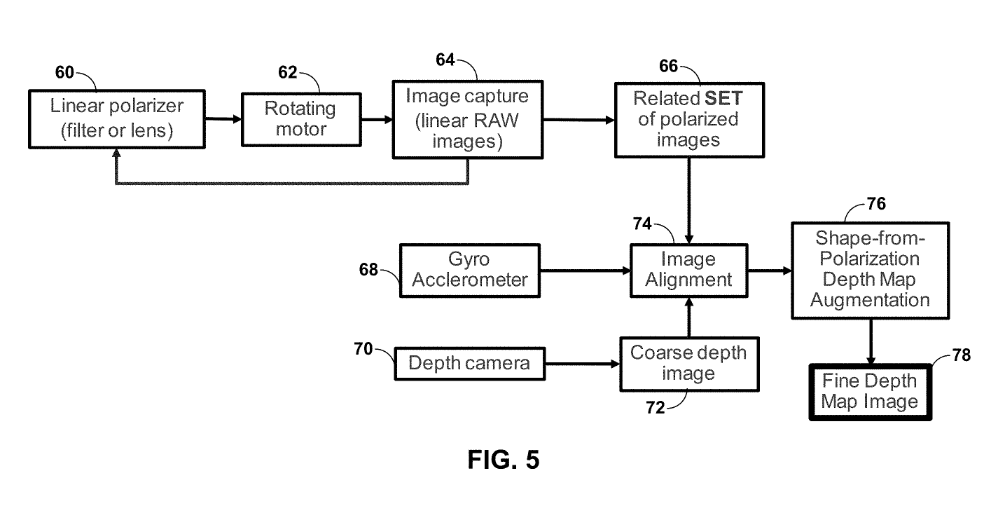

FIG. 5 is a diagram illustrating an example algorithm that, when executed, causes mobile computing device 10 to be configured to perform various aspects of the techniques described in this disclosure. Color camera 8 of mobile computing device 10 may first interface with LPU 32 to initialize LPU 32 to a known state (e.g., a polarization orientation of zero degrees), invoking motor 34 (which may also be referred to as “rotating motor 34”) to rotate LPU 32 (filter or lens) to the known state (60, 62). After initializing LPU 32, color camera 8 may initiate capture of a first image (such as a linear RAW image) in the sequence of linearly polarized images represented by CID 9 (64). Color camera 8 may repeat the foregoing steps of rotating the motor and initiating image capture, incrementing the polarization orientation by some fixed number of degrees (e.g., 45 degrees) to capture each of the sequence of linearly polarized images represented by CID 9. CID 9 may also be referred to as representing a related set of polarized images. Color camera 8 may output CID 9 (which may represent a related SET of polarized images) to camera processor 14 (66).

Concurrent with the capture of CID 9, motion sensors 36 of mobile computing device 10 may output sensor data representative of one or more of a location (e.g., global positioning system—GPS—information), orientation (such as gyroscope—gyro—information), and movement (e.g., accelerometer information) of mobile computing device 10, to camera processor 14 (68). Also concurrent with the capture of CID 9, camera processor 14 may initiate capture of DPD 13 by depth camera 12 (70, 72). DPD 13 may represent a course depth image (72).

Camera processor 14 may receive CID 9, the sensor data, and DPD 13. Camera processor 14 may perform image alignment with respect to CID 9 and DPD 13 and potentially based on the sensor data (when such sensor data is available or, in some examples, assessed as being accurate) (74). When performing image alignment using the motion information, camera processor 14 may select sensor data at or around the time of capture of each image currently being aligned to the reference image.

Camera processor 14 may also utilize sensor data at or around the time of capture of the reference image. In some examples, camera processor 14 may determine a difference in sensor data at or around the time of capture of the reference image and the sensor data at or around the time of capture of the image currently being aligned. Camera processor 14 may perform the image alignment based on this difference. More information regarding use of sensor data to facilitate image registration can be found in a project report by S. R. V. Vishwanath, entitled “Utilizing Motion Sensor Data for Some Image Processing Applications,” and dated May, 2014.

In this respect, camera processor 14 may generate a sequence of aligned linearly polarized images (which may be represented by CID 9) and an aligned depth map image (which may be represented by DMD 13). Camera processor 14 may next perform, with respect to aligned DMD 13 and based on aligned CID 9, the shape-from-polarization depth map augmentation process set forth in the Kadambi research paper (76) to generate EDMD 15 (which may also be referred to as a “fine depth map image”) (78).

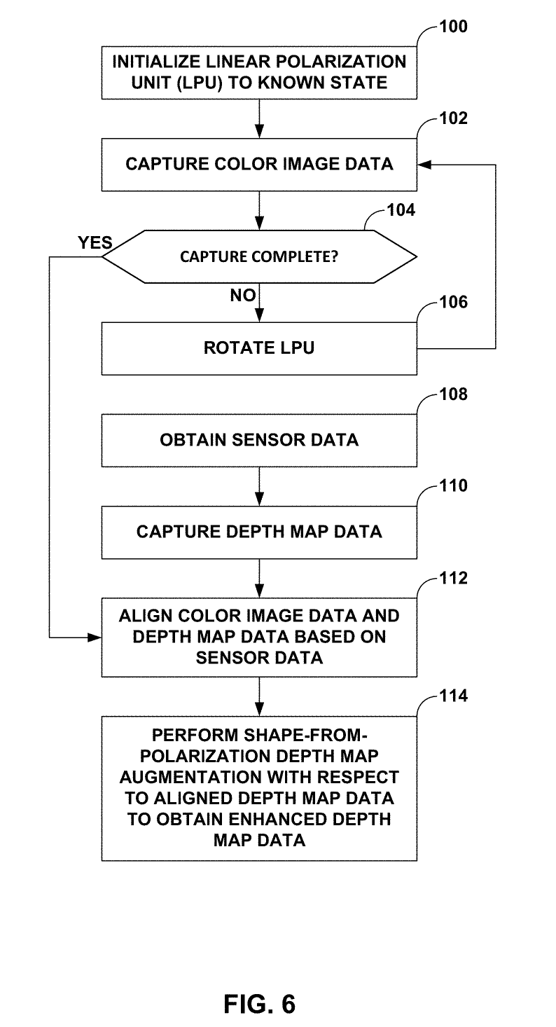

FIG. 6 is flowchart illustrating example operation of mobile computing device 10 of FIG. 1 in performing various aspects of the techniques described in this disclosure. Initially, color camera 8 of mobile computing device 10 may first interface with LPU 32 to initialize LPU 32 to a known state (e.g., a polarization orientation of zero degrees), invoking motor 34 (which may also be referred to as “rotating motor 34”) to rotate LPU 32 to the known state (100).

After initializing LPU 32, color camera 8 may initiate capture of a first image in the sequence of linearly polarized images represented by CID 9 (102). Color camera 8 may repeat the foregoing steps, incrementing the polarization orientation by some fixed number of degrees (e.g., 45 degrees) to capture each of the sequence of linearly polarized images represented by CID 9 until a pre-defined number of images are captured or capture is otherwise complete (“YES” 104, 106, 102).

In some examples, camera processor 14 may analyze each of the images to determine whether the images of CID 9 are of sufficient quality for use in the shape-from-polarization depth map augmentation process set forth in the Kadambi research paper. That is, camera processor 14 may determine metrics with regard to sharpness, blurriness, focus, lighting, or any other metric common for images, comparing one or more of the metrics to metric thresholds. When the metrics fall below, or in some instances, rise above the corresponding thresholds, camera processor 14 may continue to capture additional images, discarding the inadequate images (which may refer to images having metrics that fall below or, in some instances, above the corresponding metric thresholds). Camera processor 14 may, during the evaluation of the quality of the images, perform weighted averaging with regard to the metrics, applying more weight to the metrics determined to be more beneficial to the shape-from-polarization depth map augmentation process set forth in the Kadambi research paper.

Concurrently with the capture of CID 9, motion sensors 36 of mobile computing device 10 may output sensor data representative of one or more of a location (e.g., global positioning system—GPS—information), orientation (such as gyroscope—gyro—information), and movement (e.g., accelerometer information) of mobile computing device 10, to camera processor 14. Camera processor 14 may obtain the sensor data output by motion sensors 36 (108). Also concurrent with the capture of CID 9, camera processor 14 may initiate capture of DPD 13 by depth camera 12 (70, 72) (110).

Camera processor 14 may receive CID 9, the sensor data, and DPD 13. Camera processor 14 may align CID 9 and DPD 13 based on the sensor data (when such sensor data is available or, in some examples, assessed as being accurate) (112). In this respect, camera processor 14 may generate a sequence of aligned linearly polarized images (which may be represented by CID 9) and an aligned depth map image (which may be represented by DMD 13). Camera processor 14 may next perform the shape-from-polarization depth map augmentation process set forth in the Kadambi research paper with respect to aligned DMD 13 to generate EDMD 15 (114).

In this respect, the techniques described in this description may provide for enhanced depth maps having sub-millimeter accuracy using cameras of mobile computing devices, rather than accuracy in the millimeter range for current cameras of mobile computing devices. By enabling sub-millimeter accuracy, the techniques may allow for capture of finer model geometry, such as sharp corners, flat surfaces, narrow objects, ridges, grooves, etc. The higher resolution may allow for results that promote adoption of cameras in mobile computing devices for applications, such as virtual reality, augmented reality, three-dimensional modeling, enhanced three-dimensional (3D) image capture, etc.

In one or more examples, the functions described may be implemented in hardware, software, firmware, or any combination thereof If implemented in software, the functions may be stored on, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A mobile device configured to process a depth map image, the mobile device comprising:
a depth camera configured to capture a depth map image of a scene;
a camera including a linear polarization unit configured to linearly polarize light entering into the camera, the camera configured to rotate the linearly polarization unit during capture of the scene to generate a sequence of linearly polarized images of the scene having different polarization orientations; and
a processor configured to:
perform image registration with respect to the sequence of linearly polarized images to generate a sequence of aligned linearly polarized images; and
generate an enhanced depth map image based on the depth map image and the sequence of aligned linearly polarized images.

2. The mobile device of claim 1,
wherein the processor is further configured to determine the polarization orientation of each of the sequence of linearly polarized images, and
wherein the processor is configured to generate the enhanced depth map image based on the depth map image, the sequence of aligned linearly polarized images, and the determined polarization orientations.

3. The mobile device of claim 2, wherein the camera is further configured to synchronize rotation of the linear polarization unit and the capture of the sequence of linearly polarized images such that the difference in polarization orientations between successive linearly polarized images is fixed, and
wherein the processor is configured to determine the polarization orientation of each of the sequence of linearly polarized images as a fixed polarization orientation for each of the sequence of linearly polarized images.

4. The mobile device of claim 2, wherein the processor is configured to determine the polarization orientation of each of the sequence of linearly polarized images as a function of an extent of rotation of the linear polarization unit at a time of the capture of each of the sequence of linearly polarized images.

5. The mobile device of claim 1, further comprising one or more sensors configured to generate sensor data representative of one or more of movement, orientation, and location of the mobile device,
wherein the processor is configured to perform the image registration with respect to the sequence of linearly polarized images based on the sensor data to generate the sequence of aligned linearly polarized images.

6. The mobile device of claim 1, wherein the camera includes a motor configured to rotate the linear polarization unit.

7. The mobile device of claim 1, wherein the linear polarization unit comprises one of a linearly polarized lens or a linearly polarized filter.

8. The mobile device of claim 1, wherein the processor is configured to:
perform the image registration with respect to the sequence of linearly polarized images and the depth map image to generate a sequence of aligned linearly polarized images and an aligned depth map image; and
generate the enhanced depth map image based on the aligned depth map image and the sequence of aligned linearly polarized images.

9. The mobile device of claim 1, wherein the processor is further configured to construct a three-dimensional model of at least one aspect of the scene based on the enhanced depth map image.

10. A method of processing a depth map image, the method comprising:
capturing, by a depth camera, a depth map image of a scene;
rotating a linear polarization unit during capture of the scene by a color camera to generate a sequence of linearly polarized images of the scene having different polarization orientations;
performing image registration with respect to the sequence of linearly polarized images to generate a sequence of aligned linearly polarized images; and
generating an enhanced depth map image based on the depth map image and the sequence of aligned linearly polarized images.

11. The method of claim 10, further comprising determining the polarization orientation of each of the sequence of linearly polarized images, and
wherein generating the enhanced depth map image comprises generating the enhanced depth map image based on the depth map image, the sequence of aligned linearly polarized images, and the determined polarization orientations.

12. The method of claim 11, further comprising synchronizing rotation of the linear polarization unit and the capture of the sequence of linearly polarized images such that the difference in polarization orientations between successive linearly polarized images is fixed, and
wherein determining the polarization orientation comprises determining the polarization orientation of each of the sequence of linearly polarized images as a fixed polarization orientation for each of the sequence of linearly polarized images.

13. The method of claim 11, wherein determining the polarization orientation comprises determining the polarization orientation of each of the sequence of linearly polarized images as a function of an extent of rotation of the linear polarization unit at a time of the capture of each of the sequence of linearly polarized images.

14. The method of claim 10, further comprising obtaining sensor data representative of one or more of movement, orientation, and location of the mobile device,
wherein performing the image registration comprises performing the image registration with respect to the sequence of linearly polarized images based on the sensor data to generate the sequence of aligned linearly polarized images.

15. The method of claim 10, further comprising rotating the linear polarization unit.

16. The method of claim 10, wherein the linear polarization unit comprises one of a linearly polarized lens or a linearly polarized filter.

17. The method of claim 10,
wherein performing the image registration comprises performing the image registration with respect to the sequence of linearly polarized images and the depth map image to generate a sequence of aligned linearly polarized images and an aligned depth map image, and
wherein generating the enhanced depth map comprises generating the enhanced depth map image based on the aligned depth map image and the sequence of aligned linearly polarized images.

18. The method of claim 10, further comprising constructing a three-dimensional model of at least one aspect of the scene based on the enhanced depth map image.

19. A device configured to process a depth map image, the device comprising:
means for capturing a depth map image of a scene;
means for capturing a sequence of linearly polarized images of the scene having different polarization orientations;
means for performing image registration with respect to the sequence of linearly polarized images to generate a sequence of aligned linearly polarized images; and
means for generating an enhanced depth map image based on the depth map image and the sequence of aligned linearly polarized images.

20. The device of claim 19, further comprising means for determining the polarization orientation of each of the sequence of linearly polarized images, and
wherein the means for generating the enhanced depth map image comprises means for generating the enhanced depth map image based on the depth map image, the sequence of aligned linearly polarized images, and the determined polarization orientations.

21. The device of claim 20, further comprising means for synchronizing rotation of the linear polarization unit and the capture of the sequence of linearly polarized images such that the difference in polarization orientations between successive linearly polarized images is fixed, and
wherein the means for determining the polarization orientation comprises means for determining the polarization orientation of each of the sequence of linearly polarized images as a fixed polarization orientation for each of the sequence of linearly polarized images.

22. The device of claim 20, wherein the means for determining the polarization orientation comprises means for determining the polarization orientation of each of the sequence of linearly polarized images as a function of an extent of rotation of the linear polarization unit at a time of the capture of each of the sequence of linearly polarized images.

23. The device of claim 19, further comprising means for obtaining sensor data representative of one or more of movement, orientation, and location of the mobile device,
wherein the means for performing the image registration comprises means for performing the image registration with respect to the sequence of linearly polarized images based on the sensor data to generate the sequence of aligned linearly polarized images.

24. The device of claim 19, further comprising means for rotating the linear polarization unit.

25. The device of claim 19, wherein the linear polarization unit comprises one of a linearly polarized lens or a linearly polarized filter.

26. The device of claim 19,
wherein the means for performing the image registration comprises means for performing the image registration with respect to the sequence of linearly polarized images and the depth map image to generate a sequence of aligned linearly polarized images and an aligned depth map image, and
wherein the means for generating the enhanced depth map comprises means for generating the enhanced depth map image based on the aligned depth map image and the sequence of aligned linearly polarized images.

27. The device of claim 19, further comprising means for constructing a three-dimensional model of at least one aspect of the scene based on the enhanced depth map image.

28. A non-transitory computer-readable storage medium having stored thereon instructions that, when executed, cause one or more processors of a mobile device to:
interface with a depth camera to capture of a depth map image of a scene;
interface with a color camera to capture a sequence of linearly polarized images of the scene having different polarization orientations;
perform image registration with respect to the sequence of linearly polarized images to generate a sequence of aligned linearly polarized images; and
generate an enhanced depth map image based on the depth map image and the sequence of aligned linearly polarized images.
